(19) United States
(12) Patent Application Publication
(10) Pub. No.: US 2010/0219068 A1
(43) Pub. Date: Sep. 2, 2010

(54) Harmful Gas Treatment Apparatus and Water Treatment Apparatus

(75) Inventors: Shiro Yamauchi, Tokyo (JP); Minoru Kimura, Tokyo (JP); Shigeru Yamaji, Tokyo (JP); Masato Machida, Kumamoto (JP)

Correspondence Address: BUCHANAN, INGERSOLL & ROONEY PC, POST OFFICE BOX 1404, ALEXANDRIA, VA, 22313-1404, US

(73) Assignees: Mitsubishi Electric Corporation, Chiyoda-ku (JP); Kumamoto University, Kumamoto-shi (JP)

(21) Appl. No.: 12/087,045

(22) PCT Filed: Feb. 23, 2007
(86) PCT No.: PCT/JP2007/053376

§ 371 Date: Jun. 25, 2008

(30) Foreign Application Priority Data
Mar. 1, 2006 (JP) 2006-054385

(51) Int. Cl. C02F 1/461; B01D 53/86

(52) U.S. Cl. 204/264; 204/265; 204/263

(57) ABSTRACT

A harmful gas treatment apparatus and a water treatment apparatus uses an electrochemical device provided with a solid electrolyte membrane having ion conductivity. A first electrochemical device provided with an anode on one surface of a hydrogen ion conductive electrolyte membrane and a cathode on the other surface thereof is combined with a second electrochemical device provided with an anode on one surface of a hydroxyl ion conductive electrolyte membrane and a cathode on the other surface thereof. Both cathodes are disposed so as to face each other within an electrochemical reaction tank. Each of the cathodes is provided with TiO₂ as a metal oxide and Pt as a platinum group supported on a porous body having functions to occlude, concentrate and reduce harmful substances as a reducing catalyst. Thus, a water vapor partial pressure and an oxygen partial pressure on the both cathodes is reduced, making it possible to enhance hydrogen generation efficiency at the normal temperature and constant current.

### TECHNICAL FIELD

The present invention relates to a harmful gas treatment apparatus and a water treatment apparatus for electro-chemically reducing and decomposing harmful substances by utilizing a high reducing function of hydrogen generated on a surface of a cathode of a solid electrolyte membrane having ion conductivity.

### BACKGROUND ART

As a technology for electrochemically decomposing and removing nitrogen oxides as one of harmful substances discharged from an internal combustion engine or the like, there has hitherto been a removal method of nitrogen oxides comprising a first step of providing a pair of electrodes on a surface side of a solid electrolyte body having hydrogen ion conductivity and/or oxygen ion conductivity, applying a direct-current voltage between the both electrodes and bringing a gas to be treated containing water and nitrogen oxides into contact with the electrodes to electrolyze water, thereby producing oxygen on the anode side and reducing the nitrogen oxides to produce ammonia on the cathode side; and a second step of bringing the gas treated in the first step into contact with a catalyst to reduce the nitrogen oxides as presented in Patent Document 1.

Patent Document 1: JP8-66621A

In recent years, a nitrate ion concentration of groundwater as the source of drinking water increases in the world, and this issue is largely taken up as an environmental problem. It is considered that this is caused due to the agriculture and livestock, especially artificial fertilizers and excretions. A high-concentration nitrate ion is reduced into a nitrite ion in the body and reacts with hemoglobin in the blood or amines contained in foodstuffs to convert into methemoglobin or carcinogenic nitroamine. There is a danger leading to death due to methemoglobinemia, and a lowering of the nitrate ion is a necessary and essential problem.

As a conventional technology of water quality purification, for example, Patent Document 2 presents a method in which in an electrolytic cell, radical hydrogen generated on a cathode surface by electrolysis of water is brought into contact with a nitrate nitrogen-containing wastewater in the presence of a catalyst separated from the electrodes, thereby chemically reducing the nitrate nitrogen. In this Patent Document 2, a catalyst having palladium and copper supported on activated carbon is used as the reducing catalyst, and stainless steel, titanium, platinum and the like are used as the electrode material.

Patent Document 2: JP2004-73926A

### DISCLOSURE OF THE INVENTION

### Problems that the Invention is to Solve

In the conventional removal method of nitrogen oxides presented in the foregoing Patent Document 1, by using a catalyst functioning at a high temperature of 200° C. or higher as a reducing agent capable of reducing and decomposing nitrogen oxides and also using a device using a ceramic electrolyte functioning at a high temperature of 200° C. or higher as a solid electrolyte device having hydrogen ion conductivity and/or oxygen ion conductivity, a reduction reaction by the catalyst was processed at a high temperature of 350° C. or higher. For that reason, the harmful gas treatment apparatus itself consumed a large amount of energy, thereby making a large amount of CO₂ discharge sources. Also, since this method includes a step of producing ammonia, it was necessary to treat unreacted or residual ammonia in the second step.

On the other hand, it is possible to configure an electrolyte device by using an electrolyte (ion exchange membrane) which can be used at the normal temperature of not higher than 100° C. In that case, however, since the water molecule accompanies a positive ion or a negative ion and moves within the electrolyte membrane from an electrode of one side to an electrode of the other side, whereby a water vapor partial pressure increases in the vicinity of the electrode, there was a defect that active sites of the catalyst are covered, leading to a lowering of the catalytic reaction. There was also a problem that when oxygen is present in a gas to be treated, it hinders a reducing action.

In the treatment method of nitrate nitrogen-containing wastewater as presented in Patent Document 2, though the nitrate nitrogen is chemically reduced with, as a reducing agent, radical hydrogen generated on the cathode surface by electrolysis of water, since the cathode is not provided with a catalyst having a function to promote the hydrogen generation, a high decomposing and reducing ability cannot be expected. Also, since there is a possibility that nitrogen oxide gases and hydrogen gas as harmful gases which are discharged on the cathode side are discharged out the system, there was a problem in view of safety.

In order to improve the foregoing problems, the invention has been made and is aimed to provide a harmful gas treatment apparatus which is able to achieve the treatment at a relatively low temperature of not higher than 100° C. and which does not produce dangerous materials such as ammonia in a treatment process and is less in environmental loads.

Also, the invention is aimed to provide a safe and efficient water treatment apparatus which has a high reduction and decomposition ability of a nitrate ion and which does not discharge harmful gases out the system.

### Means for Solving the Problems

The harmful gas treatment apparatus according to the invention comprises a first electrochemical device including a first solid electrolyte membrane having positive ion conductivity, a first anode provided on one surface of the first solid electrolyte membrane and a first cathode provided on the other surface of the first solid electrolyte membrane; a second electrochemical device including a second solid electrolyte membrane having negative ion conductivity, a second anode provided on one surface of the second solid electrolyte membrane and a second cathode provided on the other surface of the second solid electrolyte membrane; a reducing catalyst provided in at least first cathode and second cathode for reducing and decomposing harmful substances in the harmful gas to be treated; and a reaction tank having a space coming into contact with both of the first cathode and the second cathode and communicating with an introduction port and a discharge port of the harmful gas to be treated.

The water treatment apparatus in a first aspect of the invention comprises an electrochemical device including a solid electrolyte membrane having ion conductivity, an anode provided on one surface of the solid electrolyte membrane and a cathode provided on the other surface of the solid electrolyte membrane; a reaction vessel accommodating this electrochemical device therein, and including an anode chamber having a space coming into contact with the anode and communicating with an introduction port and a discharge port of water, and a reaction chamber having a space coming into contact with the cathode and communicating with an introduction port and a discharge port of water to be treated; and a reducing catalyst provided in the cathode for reducing and decomposing harmful substances in water to be treated and a promoting catalyst provided in the cathode for promoting a reaction for producing hydrogen.

The water treatment apparatus in a second aspect of the invention comprises a first electrochemical device including a first solid electrolyte membrane having positive ion conductivity, a first anode provided on one surface of the first solid electrolyte membrane and a first cathode provided on the other surface of the first solid electrolyte membrane; a second electrochemical device including a second solid electrolyte membrane having negative ion conductivity, a second anode provided on one surface of the second solid electrolyte membrane and a second cathode provided on the other surface of the second solid electrolyte membrane; a reaction vessel accommodating the first electrochemical device and the second electrochemical device therein, and including an anode chamber having a space coming into contact with the first anode and communicating with an introduction port and a discharge port of water, a reaction chamber having a space coming into contact with both of the first cathode and the second anode and communicating with an introduction port and a discharge port of water to be treated, and a cathode chamber having a space coming into contact with the second cathode and communicating with the introduction port and the discharge port of water to be treated; and a reducing catalyst provided in the first cathode for reducing and decomposing harmful substances in water to be treated and a promoting catalyst provided in the first cathode for promoting a reaction for producing hydrogen.

### ADVANTAGES OF THE INVENTION

According to the harmful gas treatment apparatus of the invention, since a water vapor partial pressure and an oxygen partial pressure on the first cathode and the second cathode can be reduced, catalytic poisoning can be dissolved; and it is possible to enhance remarkably hydrogen generation efficiency at the normal temperature and constant current. Thus, it is possible to provide a harmful gas treatment apparatus which is able to achieve the treatment at a relatively low temperature of not higher than 100° C. and which does not produce dangerous materials such as ammonia in a treatment process and is less in environmental loads.

According to the water treatment apparatus in the first aspect of the invention, harmful substances can be electrochemically and chemically reduced and decomposed with good efficiency by the reducing catalyst and the promoting catalyst, both of which are provided on the cathode.

According to the water treatment apparatus in the second aspect of the invention, harmful substances can be electrochemically and chemically reduced and decomposed with good efficiency by the reducing catalyst and the promoting catalyst, both of which are provided on the first cathode; and furthermore, by combining the first electrochemical device having an electrochemically reducing function and the second electrochemical device having a harmful substance concentrating function, harmful substances can be reduced and decomposed more efficiently as compared with the case of only the first electrochemical device.

The objects, characteristic features, aspects and effects other than those described above according to the invention will be made clearer from the following detailed descriptions with reference to the drawings.

### BRIEF DESCRIPTION OF THE DRAWINGS

FIGS. 1A and 1B are a cross-sectional view to show a configuration of a harmful gas treatment apparatus as Embodiment 1 of the invention and a cross-sectional view of the principal part of a first electrochemical device, respectively.

FIG. 2 is a graph to show results of treating a harmful gas by using a harmful gas treatment apparatus as Embodiment 1 of the invention.

FIG. 3 is a view to show a configuration of a harmful gas treatment apparatus as Embodiment 2 of the invention.

FIG. 4 is a schematic view to show a nitrate ion reduction reaction by energizing an electrochemical device configuring a water treatment apparatus as Embodiment 3 of the invention.

FIG. 5 is a graph to show a nitrate ion reduction characteristic (electrochemical reduction characteristic) by energization in a water treatment apparatus as Embodiment 3 of the invention.

FIG. 6 is a view to show a configuration of a water treatment apparatus as Embodiment 3 of the invention.

FIG. 7 is a schematic view to show a reaction vessel used for the purpose of examining a nitrate ion reduction characteristic in the case of not performing energization in a water treatment apparatus as Embodiment 3 of the invention.

FIG. 8 is a graph to show a nitrate ion reduction characteristic (chemical reduction characteristic) in the case of not performing energization in a water treatment apparatus as Embodiment 3 of the invention.

FIG. 9 is a graph to show a nitrate ion reduction characteristic in the case of plating a variety of reducing catalyst metals on a Pt cathode surface in a water treatment apparatus as Embodiment 3 of the invention.

FIG. 10 is a graph to show a reaction rate constant in the case of plating a variety of reducing catalyst metals on a Pt cathode surface in a water treatment apparatus as Embodiment 3 of the invention.

FIG. 11 is a graph to show the relationship between a composition and a reaction rate constant of a reducing catalyst metal in a water treatment apparatus as Embodiment 3 of the invention.

FIG. 12 is a graph to show plating durability of a reducing catalyst metal in a water treatment apparatus as Embodiment 3 of the invention.

FIG. 13 is a graph to show the relationship between a plating time and a reaction rate constant of a reducing catalyst metal in a water treatment apparatus as Embodiment 3 of the invention.

FIG. 14 is a view to show a configuration of a water treatment apparatus as Embodiment 4 of the invention.

### BEST MODES FOR CARRYING OUT THE INVENTION

Embodiments 1 to 4 which are each a best mode for carrying out the invention are hereunder described. Embodiments 1 and 2 are each concerned with a harmful gas treatment apparatus for removing nitrogen oxides (NOx) which are a harmful substance contained in an exhaust gas discharged from an internal combustion engine or the like by means of electrochemical and chemical reduction and decomposition and discharging the gas as a clean gas. Embodiments 3 and 4 are each concerned with a water treatment apparatus for removing a nitrate ion (NO³⁻) which is a harmful substance contained in water to be treated by means of electrochemical and chemical reduction and decomposition and discharging the water as clean water.

### Embodiment 1

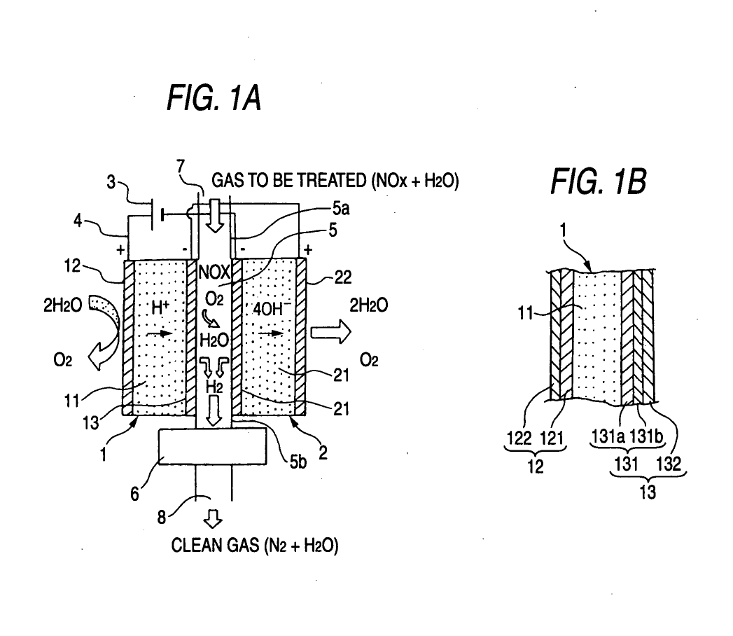

The harmful gas treatment apparatus in Embodiment 1 of the invention is described with reference to the drawings. FIG. 1A is a view to show a configuration of a hybrid cell which is a harmful gas treatment apparatus in Embodiment 1 of the invention; and FIG. 1B is a cross-sectional view to show the principal part of a first electrochemical device configuring a hybrid cell. The harmful gas treatment apparatus in the present embodiment is characterized by being configured of two electrochemical devices of a first electrochemical device 1 and a second electrochemical device 2. The first electrochemical device 1 and the second electrochemical device 2 are connected to a direct current power source 3 in series by a lead wire 4.

As illustrated in FIG. 1B, the first electrochemical device 1 is provided with a hydrogen ion conductive electrolyte membrane 11 which is a first solid electrolyte membrane having positive ion conductivity; an anode 12 which is a first anode provided on one surface of this hydrogen ion conductive electrolyte membrane 11; and a cathode 13 which is a first cathode provided on the other surface thereof. In the anode 12, an anode catalyst 121 and an anode electron conductive substrate 122 are cladded; and in the cathode 13, a cathode catalyst 131 and a cathode electron conductive substrate 132 are cladded.

On the other hand, the second electrochemical device 2 is provided with a hydroxyl ion conductive electrolyte membrane 21 which is a second solid electrolyte membrane having negative ion conductivity; an anode 22 which is a second anode provided on one surface of this hydroxyl ion conductive electrolyte membrane 21; and a cathode 23 which is a second cathode provided on the other surface thereof. In the anode 22, an anode catalyst 221 (not illustrated) and an anode electron conductive substrate 222 (not illustrated) are cladded; and in the cathode 23, a cathode catalyst 231 (not illustrated) and a cathode electron conductive substrate 232 (not illustrated) are cladded.

Each of the hydrogen ion conductive electrolyte membrane 11 and the hydroxyl ion conductive electrolyte membrane 21 is a high molecular membrane of, for example, Nafion and is used at the normal temperature because it is softened at a high temperature. A temperature range which is suitable for the use is from about room temperature to 100° C. As the anode catalyst 121 to be cladded in the anode 12 of the first electrochemical device 1, platinum (Pt) which is a promoting catalyst for promoting a reaction for producing hydrogen is used; and as the cathode catalyst 131 to be cladded in the cathode 13, platinum (Pt) which is a promoting catalyst 131a for promoting a reaction for producing hydrogen and a reducing catalyst 131b (as described later in detail) for reducing and decomposing harmful substances in a gas to be treated are used. In the anode 22 and the cathode 23 of the second electrochemical device 2, the same catalysts are disposed, too. Here, the reaction for producing hydrogen which is promoted by the promoting catalyst is a reaction in which on the cathode 13, a hydrogen ion and an electron react with each other on the electrode to produce hydrogen and a reaction in which on the cathode 23, water and an electron react with each other on the electrode to produce a hydrogen ion and hydrogen.

As materials for the anodes 12 and 22, a mixture of platinum having iridium or iridium oxide mixed therewith is used. In place of iridium, a metal such as palladium, rhodium, and ruthenium may also be used; and a mixture of one or two or more kinds of these metals may be used, too. As materials for the cathodes 13 and 23, a mixture of platinum having an amphoteric metal mixed therewith is used. Furthermore, as the cathode material, a porous body having TiO₂ as a metal oxide and Pt as a platinum group supported thereon (for example, ZSM-5 type zeolite) can be used.

In the respective anodes 12 and 22 and the respective cathodes 13 and 23, a wire gauze in which platinum is plated on an expanded metal of titanium for the purpose of strengthening the corrosion resistance is disposed as an electron conductive substrate so as to put each of the hydrogen ion conductive electrolyte membrane 11 and the hydroxyl ion conductive membrane 21 therebetween from the both sides.

A method for forming each of the electrode surfaces is briefly described. A fine particle of a metal such as platinum and iridium is mixed with a solution of Nafion which is a material of the hydrogen ion conductive electrolyte membrane 11 (or the hydroxyl ion conductive electrolyte membrane 21) together with a solvent such as isopropyl alcohol. This mixed solution is sprayed on an electrode-forming surface of the hydrogen ion conductive electrolyte membrane 11 (or the hydroxyl ion conductive electrolyte membrane 21) and then dried, whereby the solvent in the mixed solution is evaporated to form an electrode surface. Coating by spraying may be carried out before or after disposing a wire gauze as an, electron conductive substrate on the hydrogen ion conductive electrolyte membrane 11 (or the hydroxyl ion conductive electrolyte membrane 21).

Furthermore, each of the cathodes 13 and 23 is provided with a catalyst layer of TiO₂ as a metal oxide and Pt as a platinum group supported on a porous body (for example, ZSM-5 type zeolite) having functions to occlude, concentrate and reduce harmful substances as the reducing catalyst 131b for reducing and decomposing harmful substances in the gas to be treated. In the present Embodiment 1, though the reducing catalyst 131b is disposed as the cathode catalyst 131 in the cathodes 13 and 23, this reducing catalyst 131b may be provided in not only the cathodes 13 and 23 but a part or the whole of a space communicating with a space with which both of the cathodes 13 and 23 come into contact. It is desirable that gold (Au) (not illustrated) is added as an suppressive catalyst for suppressing an electrochemical reaction in which hydrogen and oxygen react with each other to produce water in either one or both of the cathodes 13 and 23.

The cathode 13 of the first electrochemical device 1 and the cathode 23 of the second electrochemical device 2 are disposed so as to face each other within an electrochemical reaction tank 5. Concretely, the electrochemical reaction tank 5 has a space with which both of the cathode 13 of the first electrochemical device 1 and the cathode 23 of the second electrochemical device 2 come into contact. An inlet side 5a of the electrochemical reaction tank 5 (in an upper part in FIG. 1A) communicates with an introduction port 7 for a gas to be treated, and the other outlet side 5b communicates with a discharge port 8. In the present embodiment, the side of the discharge port 5b of the electrochemical reaction tank 5 is connected to a catalytic reaction vessel 6. On the other hand, a space on a side of each of the anodes 12 and 22 is not required to be closed but is usually opened to the air.

The catalytic reaction vessel 6 connected to the outlet side 5b of the electrochemical reaction tank 5 is provided for the purpose of further reducing and decomposing the nitrogen oxide NOx which has not been reduced on the respective cathodes 13 and 23 and is provided with the same reducing catalyst as in the respective cathodes 13 and 23, namely a catalyst layer of TiO₂ as a metal oxide and Pt as a platinum group supported on a porous body (for example, ZSM-5 type zeolite). The treated gas which is discharged from the discharge port 8 via the catalytic reaction vessel 6 makes a clean gas from which the nitrogen oxide NOx as a harmful substance has been removed.

In the present embodiment, the catalytic reaction vessel 6 is provided on the outlet side 5b of the electrochemical reaction tank 5, so far as the reduction and decomposition reaction sufficiently proceeds within the electrochemical reaction tank 5. However, the catalytic reaction vessel 6 is not always required to be provided. For the purpose of making the reduction and decomposition reaction within the electrochemical reaction tank 5 more sufficient, it is effective to increase a surface area of each of the cathodes 13 and 23 by devising the shape of each of the cathodes 13 and 23 (for example, providing irregularities).

Next, the action is described. A gas to be treated containing a nitrogen oxide NOx (usually NO, hereinafter referred to as “NO”) as a harmful substance and water vapor H₂O is introduced from the introduction port 7 for a gas to be treated and passes through the inside of the electrochemical reaction tank 5 which is a space in which the cathode 13 of the first electrochemical device 1 and the cathode 23 of the second electrochemical device 2 face each other. Then, apart of the nitrogen oxide NO is reduced on each of the cathodes 13 and 23 with hydrogen H₂ (or a hydrogen ion H⁺) produced on each of the cathodes 13 and 23 and converted into N₂O or N₂, thereby producing water. The electrochemical reactions which occur on the anode 12 and the cathode 13 of the first electrochemical device 1 and on the anode 22 and the cathode 23 of the second electrochemical device 2 are hereunder shown.

### [First Electrochemical Device 1]

### Anodic Reaction:

H₂O →2H⁺+½O₂+2e⁻

### Cathodic Reaction:

2H⁺+½O₂+2e⁻→H₂O

2H⁺+2e⁻→H₂

2H⁺+2NO+2e⁻→N₂H₂O+½O₂

2H⁺+½NO+¼O₂+2e⁻→½N₂+H₂O

2H⁺+⅔NO+⅓O₂+2e⁻→⅓N₂O+H₂O

### [Second Electrochemical Device 2]

### Anodic Reaction:

4OH⁻→>2H₂O+O₂+4e⁻

### Cathodic Reaction:

4H₂O+4e⁻→4OH⁻+2H₂

4NO+2H₂+4e⁻→2N₂+4OH⁻

4NO+H₂+2e⁻→2N₂+O₂+2OH⁻

4NO+H₂+2e⁻→2N₂O+2OH⁻

On the reducing catalysts on the respective cathodes 13 and 23 and in the catalytic reaction vessel 6, the following reactions occur, whereby reduction and decomposition of the nitrogen oxide NO further proceed.

### [On the Cathodes 13 and 23 and in the Catalytic Reaction Vessel 6]

H₂+2NO→N₂+H₂O+½O₂

2H₂+NO+½O₂→N₂+2H₂O

3/2H₂+NO+½O₂→½N₂O 3/2H₂O

The gas to be treated in which the nitrogen oxide NO as a harmful substance has been reduced and decomposed by these electrochemical reactions and chemical reactions is discharged from the discharge port 8 as a clean gas containing N₂ and H₂O.

With respect to the reactions on the respective electrodes, when attention is paid to water, water (contained in the air in an amount of several %) is supplemented from the anode 12 of the hydrogen ion conductive electrolyte membrane 11, and a hydrogen ion (H⁺) and oxygen (O₂) are generated. The thus generated hydrogen ion passes through the inside of the hydrogen ion conductive electrolyte membrane 11, and hydrogen (H₂) is generated from the cathode 13. On the cathode 23 of the hydroxyl ion conductive electrolyte membrane 21, water is electrolyzed, and a hydroxyl ion (OH⁻) and hydrogen are generated. The hydroxyl ion as generated herein passes through the inside of the hydroxyl ion conductive electrolyte membrane 21; and on the anode 22, water is produced, and oxygen is generated. The foregoing reactions are expressed by the following chemical reaction formulae. The overall reaction as referred to herein means a chemical reaction formula in the case of overall reviewing the reactions which occur on the cathodes 13 and 23 and the anodes 12 and 22 in each of the hydrogen ion conductive electrolyte membrane 11 and the hydroxyl ion conductive electrolyte membrane 21.

### [Hydrogen Ion Conductive Electrolyte Membrane 11]

### Cathode 13:

4H⁺+4e⁻→2H₂

### Anode 12:

2H₂O→4H⁺+O₂+4e⁻

### Overall Reaction:

2H₂O→2H₂+O₂

### [Hydroxyl Ion Conductive Electrolyte Membrane 21]

### Cathode 23:

4H₂O+4e⁻→4H⁻+2H₂

### Anode 22:

4OH⁻→2H₂O+O₂+4e⁻

### Overall Reaction:

2H₂O→2H₂+O₂

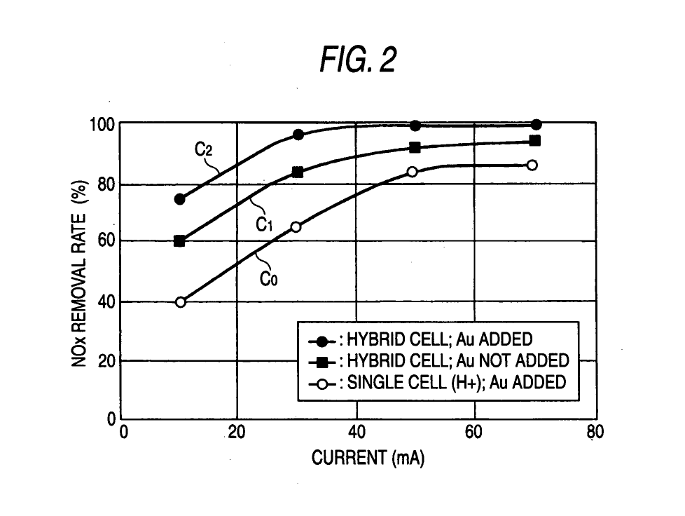

FIG. 2 shows characteristics obtained as a result of treating a harmful gas by using the harmful gas treatment apparatus in the present embodiment. In the drawing, a characteristic C0 shown by a white circle (◯) is a characteristic in the case of adding an suppressive catalyst Au for suppressing the production of water in a single cell using the first electrochemical device 1 singly; a characteristic C1 shown by a black square (▪) is a characteristic in the case of not adding an suppressive catalyst Au in a hybrid cell in the present embodiment; and a characteristic C2 shown by a black circle () is a characteristic in the case of adding an suppressive catalyst Au in a hybrid cell in the present embodiment. In the present experiment, an electrochemical device having an effective reaction area of 6 cm² was used; the experiment system was kept at a temperature of 70° C.; a water vapor saturated gas having an NO concentration of 1,000 ppm and an O₂ concentration of 5% was introduced at a flow rate of 50 mL/min into the electrochemical reaction tank 5; and a constant-current power source with direct current was connected.

Even in the characteristic C0 in the case of using singly the first electrochemical device 1, an NOx removal rate increased with an increase of the current. On the other hand, in the characteristic C1 in the case of using the hybrid cell according to the present embodiment, the NOx removal rate was further enhanced. In the characteristic C2 in the case of adding the suppressive catalyst Au for suppressing the production of water in each of the cathodes 13 and 23 of the hybrid cell in the present embodiment, the highest NOx removal rate was exhibited under energization at the same current. Thus, in accordance with the harmful gas treatment apparatus according to the present embodiment, it is possible to remove NOx in a high removal rate of substantially 100%.

The harmful gas treatment apparatus in the present embodiment mainly has two characteristic features. First of all, with respect to a first characteristic feature, since by combining the first electrochemical device 1 and the second electrochemical device 2, water produced in the first electrochemical device 1 can be removed in the second electrochemical device 2, a water vapor partial pressure of the cathode 13 can be reduced; and it is possible to dissolve catalytic poisoning (in the case where the water vapor partial pressure increases in the vicinity of the cathode, active sites of the catalyst are covered, leading to a lowering of the catalytic reaction).

Concretely, in the first electrochemical device 1, water is produced on the cathode 13 of the hydrogen ion conductive electrolyte membrane 11; and water on the side of the anode 12 moves into the cathode 13 of the hydrogen ion conductive electrolyte membrane 11 due to electroendosmosis. On the other hand, in the second electrochemical device 2, water is electrolyzed to produce hydrogen on the cathode 23 of the hydroxyl ion conductive electrolyte membrane 21; and water on the side of the cathode 23 moves into the side of the anode 22 of the hydroxyl ion conductive electrolyte membrane 21 due to electroendosmosis. That is, in the case of using singly the first electrochemical device 1, though the water vapor partial pressure of the cathode 13 increases with a lapse of time, by combining the first electrochemical device 1 and the second electrochemical device 2, water produced in the first electrochemical device 1 can be removed in the second electrochemical device 2.

A second characteristic feature resides in the matter that by reducing an oxygen (O₂) partial pressure in each of the cathodes 13 and 23, reaction efficiency of NO is enhanced (when oxygen is present in the gas to be treated, the oxygen hinders a reducing action). In the first electrochemical device 1, water is electrolyzed on the side of the anode 12; the hydrogen ion moves into the side of the cathode 13; and oxygen retains on the side of the anode 12 and is discharged into the air. In the second electrochemical device 2, water is electrolyzed on the cathode 23 to produce hydrogen and a hydroxyl ion; this hydroxyl ion moves into the side of the anode 22; and water and oxygen are produced.

That is, as illustrated in FIGS. 1A,1B, the harmful gas treatment apparatus in the present embodiment is configured such that oxygen is produced and discharged on the side of each of the anodes 12 and 22, and the oxygen partial pressure in each of the cathodes 13 and 23 is reduced. Each of the cathodes 13 and 23 is provided with a catalyst layer of TiO₂ as a metal oxide and Pt as a platinum group supported on a porous body having functions to occlude, concentrate and reduce harmful substances as the reducing catalyst 131b for reducing and decomposing harmful substances in the gas to be treated, and the reduction reaction of the harmful substances is efficiently promoted. By adding gold (Au) as an suppressive catalyst for suppressing an electrochemical reaction in which hydrogen and oxygen react with each other to produce water in the cathode 13 of the first electrochemical device 1 or the cathode 23 of the second electrochemical device 2, the production of hydrogen in each of the cathodes 13 and 23 increases, and the NO reduction reaction is further promoted.

By having these two characteristic features, the harmful gas treatment apparatus according to the present embodiment has become possible to enhance remarkably the H₂ production efficiency at the normal temperature and constant current. Since the reaction takes place at the normal temperature, the generation of a large amount of CO₂ as in conventional examples employing a high temperature of 200° C. or higher (see, for example, Patent Document 1) does not occur and ammonia as a harmful substance is not produced during the reaction of the gas to be treated, and therefore, environmental loads are low. Furthermore, since not only ammonia treatment is not necessary, but equipment such as a heater is not necessary because of use at the normal temperature, it has become possible to provide a cheap harmful gas treatment apparatus with a simple configuration.

### Embodiment 2

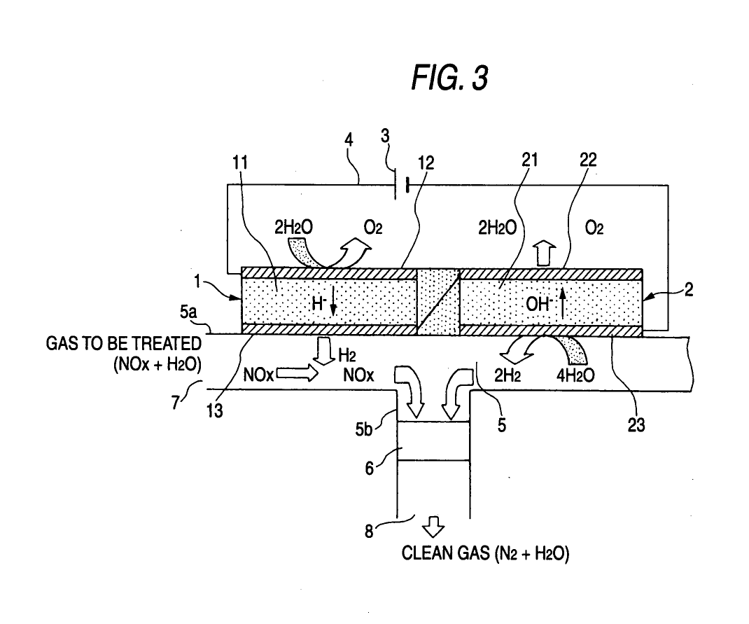

FIG. 3 is a view to show a configuration of a hybrid cell as a harmful gas treatment apparatus in Embodiment 2 of the invention. In the drawing, portions which are identical with or equivalent to those in FIG. 1 are given the same symbols. In the foregoing Embodiment 1, the surface of the cathode 13 of the first electrochemical device 1 and the surface of the cathode 23 of the second electrochemical device 2 are disposed so as to face each other. On the other hand, in the present embodiment, as illustrated in FIG. 3, the surface of the cathode 13 of the first electrochemical device 1 and the surface of the cathode 23 of the second electrochemical device 2 are disposed on the same plane. Since other configuration and action of the harmful gas treatment apparatus in the present embodiment are the same as those in the foregoing Embodiment 1, their explanations are omitted. In the harmful gas treatment apparatus according to the present embodiment, the same effects as in the foregoing Embodiment 1 were also obtained.

### Embodiment 3

The water treatment apparatus in an embodiment of the invention is hereunder described with reference to the drawings. In the foregoing Embodiments 1 and 2, the harmful gas treatment apparatus which is provided with an electrochemical device using a hydrogen ion conductive or hydroxyl ion conductive solid electrolyte membrane has been described. In the present Embodiment 3 and Embodiment 4 as described later, a water treatment apparatus in which this electrochemical device is applied, for the nitrate ion reduction in water is described. In the drawings, identical or equivalent portions are given the same symbols.

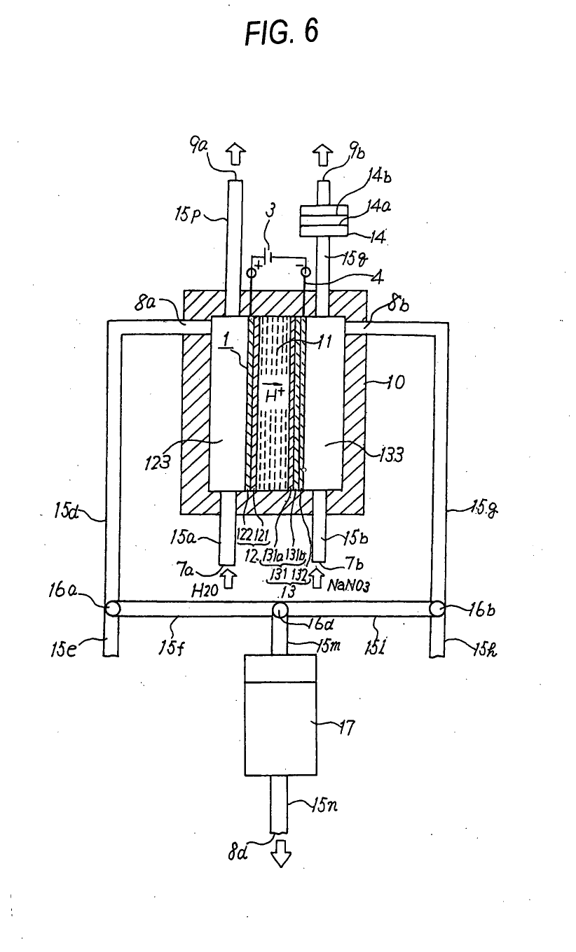

FIG. 6 is a view to show a configuration of a water treatment apparatus as Embodiment 3 of the invention. The electrochemical device 1 configuring the water treatment apparatus in the present Embodiment 3 is provided with a hydrogen ion conductive electrolyte membrane 11 which is a solid electrolyte membrane having hydrogen ion (H⁺) conductivity; an anode 12 provided on one surface of this hydrogen ion conductive electrolyte membrane 11; and a cathode 13 provided on the other surface thereof. In the anode 12, an anode catalyst 121 and an anode electron conductive substrate 122 are cladded; and in the cathode 13, a cathode catalyst 131 and a cathode electron conductive substrate 132 are cladded. The anode 12 and the cathode 13 are connected to a direct current power source 3 in series by a lead wire 4.

As the hydrogen ion conductive electrolyte membrane 11, a high molecular membrane, for example, Nafion (a trade name: Nafion 117, manufactured by E.I. du Pont de Nemours and Company) is used likewise the foregoing Embodiments 1 and 2. In each of the anode 12 and the cathode 13, a wire gauze in which platinum is plated on an expanded metal of titanium for the purpose of strengthening the corrosion resistance is disposed as an electron conductive substrate so as to put the hydrogen ion conductive electrolyte membrane 11 therebetween from the both sides. The anode 12 is provided with, as the anode catalyst 121, Platinum (Pt) deposited on one surface of the hydrogen ion conductive electrolyte membrane 11 by means of electroless plating.

The cathode 13 is provided with, as the cathode catalyst 131, a promoting catalyst 131a for promoting the reaction for producing hydrogen and a reducing catalyst metal 131b for reducing and decomposing a nitrate ion as a harmful substance. In the present Embodiment 3, platinum (Pt) deposited on a surface of the side of the cathode 13 of the hydrogen ion conductive electrolyte membrane 11 by means of electroless plating was used as the promoting catalyst 131a; and a metal containing at least one of copper (Cu), nickel (Ni) and palladium (Pd) or a metal alloy (for example, Cu—Ni, Cu—Pd, and Ni—Pd) was used as the reducing catalyst metal 131b. Such reducing catalyst metal 131b is formed on an upper surface of platinum as the promoting catalyst 131a by means of constant-current electroplating. Effects of such reducing catalyst metal 131b are described later in detail.

The thus configured electrochemical device 1 is accommodated in a reaction vessel 10 as illustrated in FIG. 6. The reaction vessel 10 is provided with an anode chamber 123 and a reaction chamber 133 which are partitioned from each other by an electrochemical device 1. The anode chamber 123 has a space coming into contact with the anode 12; and its inlet side (in a lower part in FIG. 6) is connected to a conduit 15a communicating with an introduction port 7a for water, i.e., ion exchange water in the present embodiment, whereas the other outlet side (in an upper part in FIG. 6) is connected to a conduit 15d for forming an ion exchange water discharge port 8a and a conduit 15p communicating with a gas discharge port 9a. The conduit 15d is connected to conduits 15f, 15m and 15n and communicates with a clean water discharge port 8d.

The reaction chamber 133 for reducing and decomposing harmful substances in water to be treated has a space coming into contact with the cathode 13; and its inlet side (in a lower part in FIG. 6) is connected to a conduit 15b communicating with an introduction port 7b for water to be treated, whereas the other outlet side (in an upper part in FIG. 6) is connected to a conduit 15g for forming a treated water discharge port 8b and a conduit 15q communicating with a gas discharge port 9b.

An anode chamber discharge liquid which is discharged from the anode chamber 123 and a reaction chamber discharge liquid which is discharged from the reaction chamber 133 pass through the conduits 15d and 15f and the conduits 15g and 15i, respectively, come together in the conduit 15m and are mixed in a pH adjustment tank 17. The treated liquid, the pH of which has been adjusted, passes through the conduit 15n and is discharged from the clean water discharge port 8d. The anode chamber discharge liquid becomes acidic because a hydrogen ion is produced on the anode 12; and the reaction chamber discharge liquid becomes alkaline because a hydroxyl ion is produced on the cathode 13. These discharge liquids are adjusted with respect to a flow amount by operating switching valves 16a, 16b and 16d, adjusted so as to have a dischargeable pH and then discharged. With respect to the anode chamber discharge liquid or the reaction chamber discharge liquid, there may be the case where the pH adjustment is not necessary depending upon a degree of the pH. In that case, these discharge liquids can be discharged from a conduit 15e and a conduit 15h, respectively by switching the switching valves 16a and 16b.

Furthermore, the conduit 15q for making the reaction chamber 133 communicate with the gas discharge port 9b is provided with a harmful substance removing filter 14 for removing nitrogen oxides and hydrogen as poisonous gases to be discharged from the reaction chamber 133. As a filter 14a for removing the nitrogen oxides, a platinum-group catalyst supported on a porous metal oxide was used. Concretely, a catalyst in which a platinum fine particle is fixed onto a surface of a fine particle sintered body (porous body) of a metal oxide, for example, titanium dioxide, zirconium dioxide, aluminum oxide, silicon oxide, magnesium oxide, and tin oxide can be used. In the present embodiment, a catalyst prepared by keeping HY Zeolite having 1 wt % of platinum supported thereon in a filter state on an anti-corrosive gauze.

As a filter 14b for removing hydrogen, a platinum-group catalyst supported on a porous body can be used. Concretely, a catalyst prepared by supporting 1 wt % of platinum as a platinum-group catalyst on a porous body such as air-permeable carbon paper and a filter. Chemical reaction formulae which occur on the harmful substance removing filter 14 are described later.

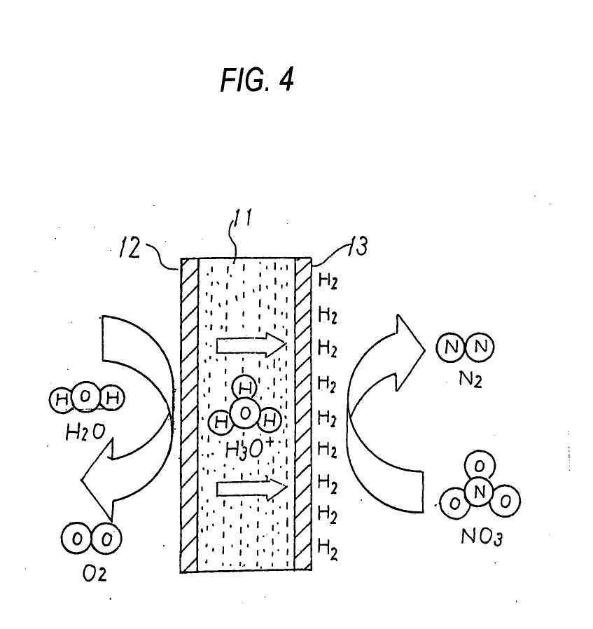

Next, the action of the water treatment apparatus provided with the electrochemical device 1 in the present Embodiment 3 is described with reference to FIG. 6 and FIG. 4. FIG. 4 shows a nitrate ion reduction reaction by energization in the electrochemical device 1. An NaNO₃ aqueous solution (water to be treated) containing a nitrate ion (NO₃⁻) as a harmful substance is introduced from the introduction port 7b for water to be treated and fed into the reaction chamber 133 as a space coming into contact with the cathode 13 of the electrochemical device 1. Ion exchange water is introduced from the introduction port 7a for ion exchange water and fed into the anode chamber 123 as a space coming into contact with the anode 12 of the electrochemical device 1.

At that time, water (H₂O) is decomposed, and oxygen (O₂) is generated on the surface of the anode 12. H⁺ and H₃O⁺ as thus generated herein are conducted within the hydrogen ion conductive electrolyte membrane 11, move into the side of the cathode 13 and cause an electrochemical reduction reaction with NO₃⁻. Furthermore, H⁺ and H₃O⁺ generate H₂ on the surface of the cathode 13, and a chemical reduction reaction of the nitrate ion simultaneously proceeds. The electrochemical reactions and chemical reactions which occur on the anode 12 and the cathode 13 of the electrochemical device 1 are shown below.

### [Electrochemical Device 1]

Anodic reaction:

H₂O→2H⁺+½O₂+2e⁻

Cathodic reaction:

NO₃⁻+6H⁺+5e⁻→½N₂+3H₂O

### (Electrochemical Reduction Reaction)

2H⁺+2e⁻→H₂

NO₃⁻ 5/2H₂→½N₂+2H₂O+OH^{- (chemical reduction reaction)}

The foregoing electrochemical reduction reaction and chemical reduction reaction of nitrate ion occur in the reaction chamber 133, and at that time, a nitrogen oxide gas equilibrium to the nitrate ion is present in a vapor phase part of the reaction chamber 133. The hydrogen gas which is electrochemically generated on the cathode 13 contributes to the chemical reduction reaction of the nitrate ion, and a part thereof moves as an unreacted gas into the vapor phase part of the reaction chamber 133. These nitrogen oxide gas and hydrogen gas are removed by the harmful substance removing filter 14. The chemical reaction formulae which occur on the harmful substance removing filter 14 are shown below.

### [Reactions on the Harmful Substance Removing Filter 14]

2H₂+NO₂→N₂+2H₂O

2H₂NO+½O₂→N₂+2H₂O

3/2H₂+NO+½O₂→½N₂O+ 3/2H₂O

H₂+N₂O→N₂+H₂O

2H₂+O₂→2H₂O

With respect to the water treatment apparatus provided with the electrochemical device 1 in the present Embodiment 3, results obtained by carrying out various experiments and considerations are described. Here, Nafion 117 having an effective membrane area of 6.0 cm² (manufactured by E.I. du Pont de Nemours and Company) was used as the hydrogen ion conductive electrolyte membrane 11; 7 mL of an NaNO₃ aqueous solution having a concentration of 3,000 ppm as a liquid to be treated was filled in the reaction chamber 133; ion exchange water was filled in the anode chamber 123; and energization was respectively performed for 3 hours at room temperature under a constant-current condition (50 mA or 100 mA). The nitrate ion concentration was measured at intervals of every 30 minutes by using an ion selective electrode (compact nitrate ion meter: Cardy C-141 Model, manufactured by HORIBA, LTD.).

For the purpose of reviewing the effects of a metal or a metal alloy (reducing catalyst metal) containing at least one of copper (Cu), nickel (Ni) and palladium (Pd) which is used as the reducing catalyst metal 131b in the present embodiment, catalysts prepared by constant-current electroplating the surface of the cathode 13 with, as the reducing catalyst metal 131b, Cu, Ni, Pd, Cu—Ni, Cu—Pd and Ni—Pd, respectively were prepared and used in the following experiments. An electroplating condition at that time (current value and plating time) is shown in Table 1.

TABLE 1

| | Cu | Ni | Pd | Cu—Ni | Cu—Pd | Ni—Pd |
|---|---|---|---|---|---|---|
| Current value (mA) | 100 | 60 | 100 | 60 | 100 | 60 |
| Plating time (min) | 3 | 5 | 3 | 5 | 3 | 5 |

### [Nitrate Ion Reduction Characteristic by Energization]

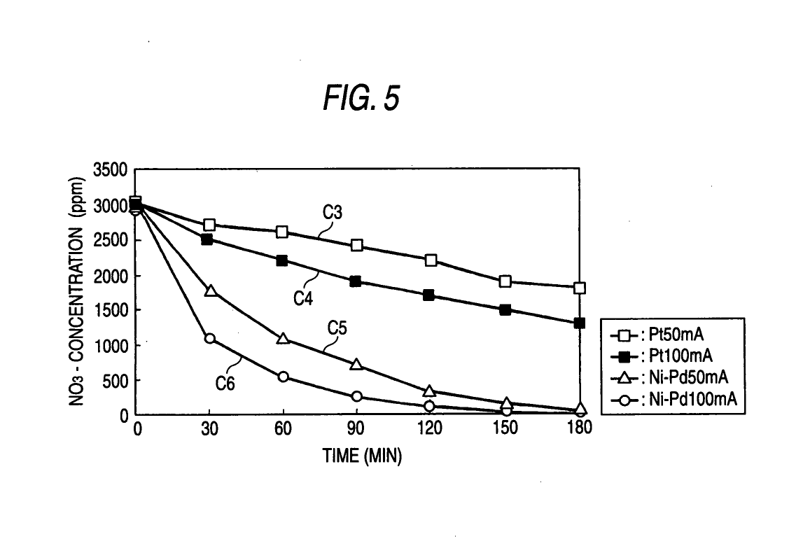

Two kinds of a Pt cathode and a Pt cathode having Ni—Pd as the reducing catalyst metal 131b electroplated thereon were prepared as the cathode 13 and energized at a current value of 50 mA and 100 mA, respectively, and a time dependency of the nitrate ion concentration was examined. As a result, the obtained characteristic is shown in FIG. 5. In FIG. 5, the ordinate stands for a nitrate ion concentration (ppm); and the abscissa stands for a time (min). A characteristic C3 shown by a white square (□) is a characteristic in the case of performing energization at 50 mA on a Pt cathode; a characteristic C4 shown by a black square (▪) is a characteristic in the case of performing energization at 100 mA on a Pt cathode; a characteristic C5 shown by a white triangle (Δ) is a characteristic in the case of performing energization at 50 mA on a Pt cathode having Ni—Pd electroplated thereon; and a characteristic C6 shown by a white circle (◯) is a characteristic in the case of performing energization at 100 mA on a Pt cathode having Ni—Pd electroplated thereon.

As shown in FIG. 5, a nitrate ion reduction characteristic obtained in the characteristics C5 and C6 in the case of using a Pt cathode having Ni—Pd as the reducing catalyst metal 131b electroplated thereon was higher than that in the characteristics C3 and C4 in the case of using a Pt cathode. However, even in the case of using either of the cathodes, the nitrate ion concentration decreased with a lapse of time; and a decrease of the nitrate ion concentration in the characteristics C4 and C6 in the case of performing energization at a current value of 100 mA as a current value was larger than that in the characteristics C3 and C5 in the case of performing energization at a current value of 50 mA as a current value. It is considered that this was caused due to the matter that by increasing the current value, the generation of H₃O⁺ by electrolysis of H₂O becomes active, whereby the nitrate ion reduction by H₂ becomes easy to occur.

### [Nitrate Ion Reduction Characteristic by Hydrogen Bubbling]

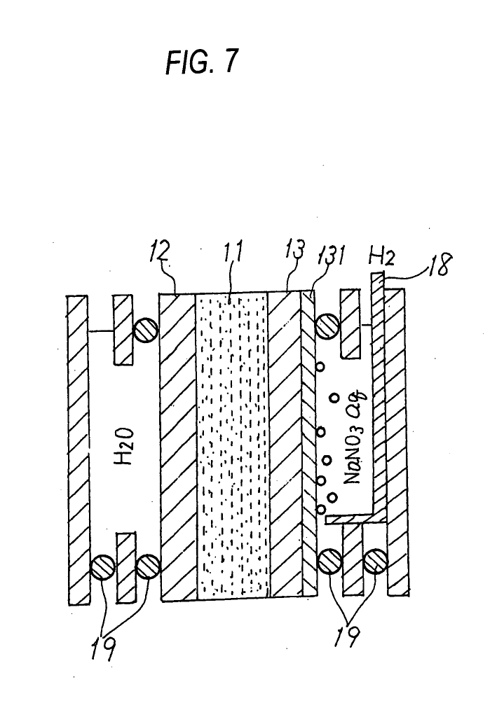

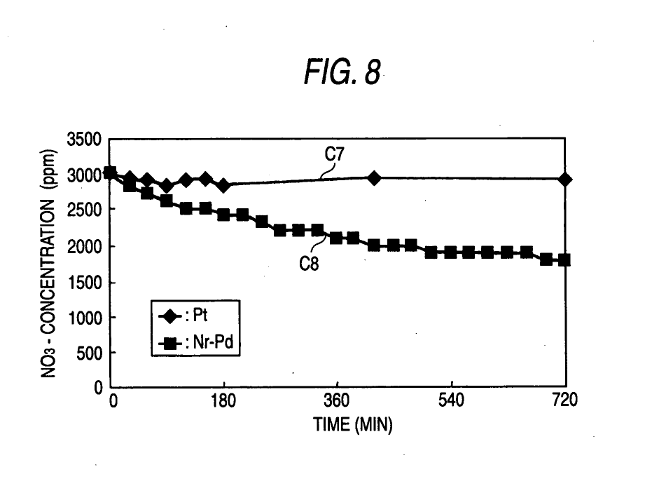

In order to confirm that the foregoing reduction reaction was caused due to an electrochemical reducing effect, whether or not the nitrate ion reduction reaction proceeds by preparing a reactor structure as illustrated in FIG. 7 and feeding a hydrogen gas from the outside without performing energization was reviewed. Two kinds of a Pt cathode and a Pt cathode having Ni—Pd electroplated thereon were prepared as the cathode 13, H₂ was bubbled on the side of the cathode 13 at a constant flow rate (less than 1 mL/min) for 12 hours by a hydrogen generator without performing energization, and the nitrate ion concentration was measured. As a result, the obtained characteristic is shown in FIG. 8. In FIG. 8, the ordinate stands for a nitrate ion concentration (ppm); and the abscissa stands for a time (min). A characteristic C7 shown by a black rhombus (♦) is a characteristic in the case of using a Pt cathode; and a characteristic C8 shown by a black square (▪) is a characteristic in the case of using a Pt cathode having Ni—Pd electroplated thereon.

As shown in FIG. 8, in the characteristic C7 in the case of using a Pt cathode, it is noted that the nitrate ion concentration did not substantially decrease and that the nitrate ion reduction reaction did not take place by bubbling with hydrogen. In the characteristic C8 in the case of using a Pt cathode having Ni—Pd electroplated thereon, it is noted that though the nitrate ion concentration gently decreased, the rate of reaction largely decreased as compared with the case of performing energization (the characteristics C5 and C6 in FIG. 5). From these matters, it is considered that the nitrate ion reduction reaction on the side of the cathode 13, namely in the reaction chamber 133 is promoted by an electrochemical reducing effect on the membrane surface of the hydrogen ion conductive electrolyte membrane 11.

[Reducing Catalyst Metal Plating Effect onto Cathode Surface]

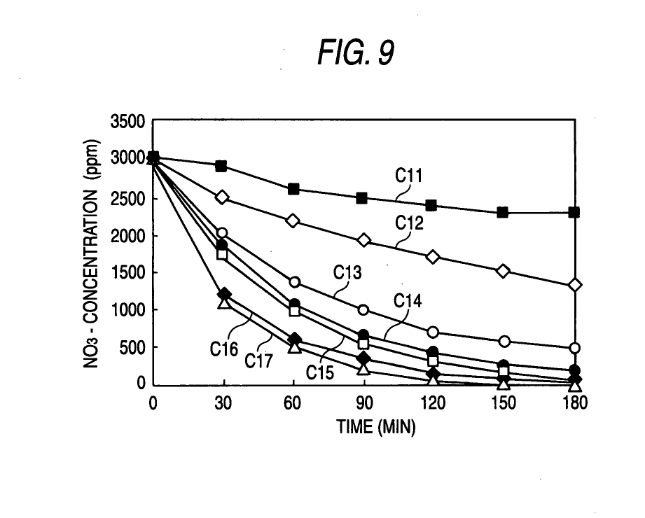

A reducing effect of the reducing catalyst metal 131b which is formed by constant-current electroplating on the Pt cathode 13 was reviewed. As shown in Table 1, various reducing catalyst metals 131b were electroplated on the surface of the Pt cathode at a constant current (60 mA or 100 mA) so as to have a thickness of 1 micron, and energization at a constant current (100 mA) was performed by using the respective cathodes 13, and the nitrate ion concentration was measured. As a result, the obtained characteristic is shown in FIG. 9. In FIG. 9, the ordinate stands for a nitrate ion concentration (ppm); and the abscissa stands for a time (min). A characteristic C11 shown by a black square (▪) is a characteristic in the case of using a Pd-plated cathode; a characteristic C12 shown by a white rhombus (⋄) is a characteristic in the case of using a Pt cathode; a characteristic C13 shown by a white circle (◯) is a characteristic in the case of using an Ni-plated cathode; a characteristic C14 shown by a black circle () is a characteristic in the case of using a Cu—Ni-plated cathode; a characteristic C15 shown by a white square (□) is a characteristic in the case of using a Cu-plated cathode; a characteristic C16 shown by a black rhombus (♦) is a characteristic in the case of using a Cu—Pd-plated cathode; and a characteristic C17 shown by a white triangle (Δ) is a characteristic in the case of using an Ni—Pd-plated cathode.

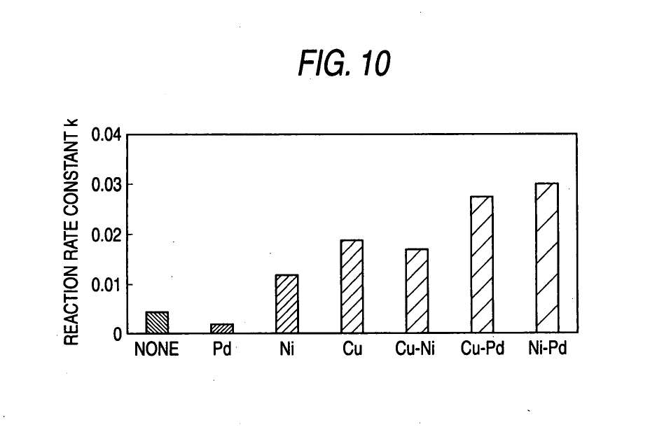

As shown in FIG. 9, though a decrease amount of the nitrate ion concentration varies with the kind of the plated reducing catalyst metal 131b, a decrease curve of substantially the same shape was obtained. On the assumption that the nitrate ion reduction reaction is a primary reaction (C═C₀ exp(−kt)), respective reaction rate constants k in the case of plating the surface of the Pt cathode with various reducing catalyst metals 131b were calculated based on these concentration change curves. The results are shown in FIG. 10. In the case where the surface of the Pt cathode is plated with various reducing catalyst metals 131b, the reaction rate constant k increases except for the case of Pd. The reaction rate constant k shows a sequence of Pd<Ni<Cu—Ni<Cu<Cu—Pd<Ni—Pd; and the activity in the case of using an alloy metal tends to be higher than that in the case of using a single metal. From these matters, it is clear that the catalytic action of the reducing catalyst metal 131b on the surface of the cathode 13 gives remarkable influences against the nitrate ion reduction characteristic.

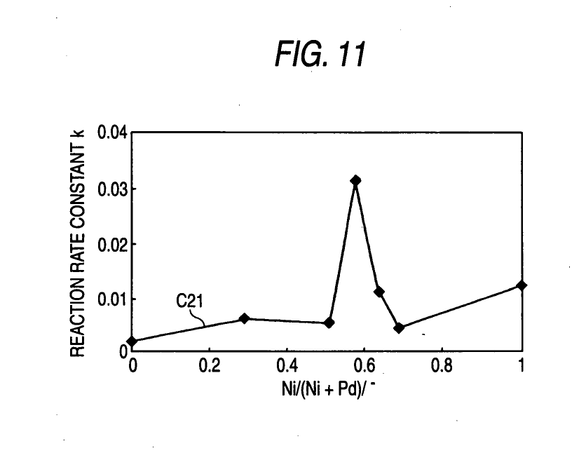

With respect to Ni—Pd exhibiting the largest reaction rate constant among the reducing catalyst metals 131b, an influence (composition dependency) which a composition ratio thereof gives to the nitrate ion reduction characteristic was examined. An Ni—Pd-plated membrane having a varied composition was prepared on the surface of the Pt cathode by changing a composition of a plating bath during performing electroplating, the nitrate ion concentration was measured due to energization by using this membrane, and a reaction rate constant k was determined. As a result, a characteristic C21 thus obtained is shown in FIG. 11. In FIG. 11, the ordinate stands for a reaction rate constant k; and the abscissa stands for an Ni—Pd composition.

As shown in the characteristic C21 of FIG. 11, it was noted that the reaction rate constant k depends upon the plating composition and that the activity is highest at Ni/(Ni+Pd)=0.58. With respect to Cu—Ni and Cu—Pd, the same experiment was carried out. As a result, the reaction rate constant also depended upon the plating composition, and the activity was highest at Cu/(Cu+Ni)=0.37 and Cu/(Cu+Pd)=0.56, respectively. From these matters, it may be said that an optimal value exists in the composition ratio of the reducing catalyst metal composed of an alloy metal.

### [Reproducibility of Reducing Effect of Plated Reducing Catalyst Metal]

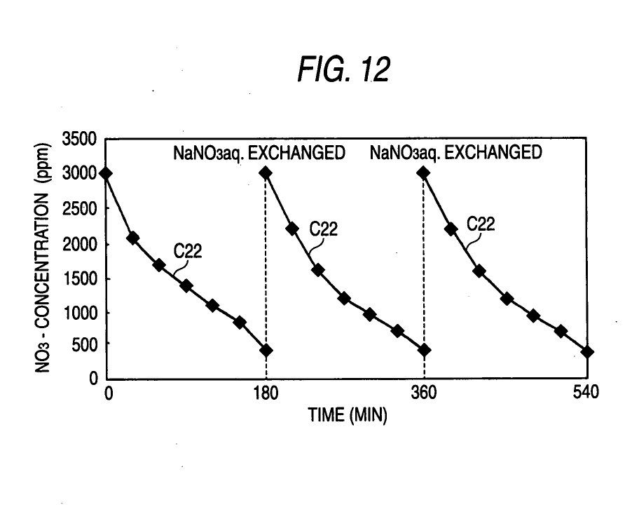

Reproducibility of the reducing effect of the reducing catalyst metal 131.b which is formed by constant-current electroplating a Pt cathode was examined. By using a Pt cathode plated with an Ni—Pd membrane exhibiting the largest reaction rate constant k as the reducing catalyst metal 131b, energization was performed at a constant current (100 mA) for 9 hours, and an NaNO₃ aqueous solution having a concentration of 3,000 ppm was exchanged by new one at intervals of every 3 hours, and durability of the Ni—Pd membrane was examined. As a result, a characteristic C22 thus obtained is shown in FIG. 12. In the energization of 9 hours, from the matters that concentration change curves of three times have a shape substantially the same and that a large difference is not observed even in a final nitrate ion concentration, the same reducing effect was obtained in all of the three occasions, and deterioration in the activity of the Ni—Pd membrane was not found.

### [Dependency Upon Plating Amount of Reducing Catalyst Metal]

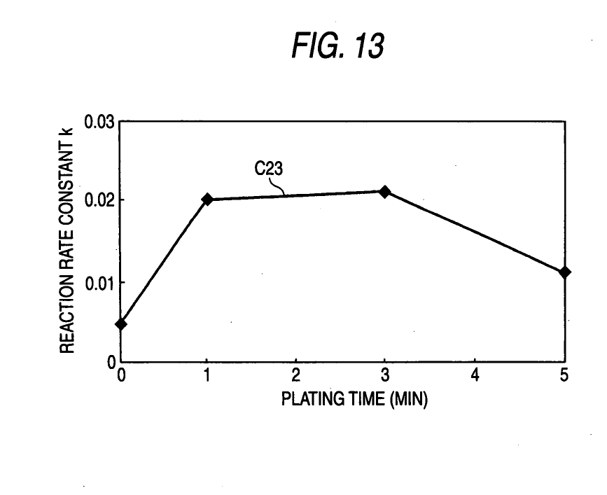

An influence which the plating amount of the reducing catalyst metal 131b which is formed on a Pt cathode by constant-current electroplating gives to the nitrate ion reduction characteristic was examined. In this experiment, since when an Ni—Pd membrane exhibiting the largest reaction rate constant k is used as the reducing catalyst metal 131b, it is difficult to make the plating composition identical every time and it is difficult to observe an influence by only the plating amount, Cu exhibiting the largest reaction rate constant k among the reducing catalyst metals 131b composed of a single metal was used. The Pt cathode was electroplated at a constant current (100 mA) with the same plating bath while varying a plating time to 1 minute, 3 minutes and 5 minutes, respectively, thereby forming a Cu membrane. By using each of the obtained cathodes 13, the nitrate ion reduction characteristic was measured. As a result, a characteristic C23 thus obtained is shown in FIG. 13. In FIG. 13, the ordinate stands for a reaction rate constant k; and the abscissa stands for a plating time (min).

As shown in the characteristic C23 of FIG. 13, a sample using the cathode 13 obtained by electroplating Cu for 3 minutes exhibited the largest reaction rate constant k. An XRF measurement was performed in five places with respect to each of the cathodes having a varied plating amount, and a composition of the membrane after plating was examined. As a result, it was noted that the cathode 13 obtained by electroplating for 3 minutes was most uniformly plated with Cu. From these matters, it is considered that the activity of the reducing catalyst metal 131b does not depend upon its plating amount and that high activity is obtained by plating uniformly the membrane surface. Also, since an increase of the plating amount and the activity as the catalyst did not coincide with each other, it may be said that an optimal value exists in the plating amount of the reducing catalyst metal 131b.

### [Results of Analysis of Treated Water by Ion Chromatography]

Each ion concentration and selectivity in an aqueous solution when nitrate ion reduction in an NaNO₃ aqueous solution as water to be treated was performed by using a Pt cathode having Ni—Pd as the reducing catalyst metal 131b electroplated thereon are shown in Table 2. After starting energization, the NaNO₃ aqueous solution was collected at intervals of every 30 minutes and analyzed by ion chromatography. As a result, NO₂⁻ was not substantially detected; its selectivity was not more than 2%; and it was reduced with a lapse of time, whereby its concentration decreased. On the other hand, NH₄⁺ increased with a decrease of NO₃⁻, and an NH₄⁺ selectivity was 25.6% in average. The NH₄⁺ selectivity as referred to herein expresses a proportion of an ammonia ion which accounts for in nitrogen compounds after the electrochemical, reaction. From the foregoing analysis results of ion chromatography, it is considered that about 75% of the reduced nitrate ion is converted into N₂ or N₂O.

TABLE 2

| | NO₃⁻ | NO₂⁻ | NH₄⁺ | NH₄⁺ | N₂/N₂O |
|---|---|---|---|---|---|
| Reaction time | concentration | concentration | concentration | selectivity | selectivity |
| (min) | (10² ppm) | (10² ppm) | (10² ppm) | (%) | (%) |
| 0 | 30.08 | — | — | — | — |
| 60 | 23.03 | 0.14 | 2.50 | 36 | 54 |
| 90 | 19.85 | 0.13 | 2.56 | 25 | 75 |
| 120 | 17.70 | 0.10 | 2.84 | 23 | 77 |
| 150 | 15.20 | 0.08 | 3.14 | 21 | 79 |
| 180 | 14.82 | 0.07 | 3.52 | 23 | 77 |

in the present Embodiment 3, though the hydrogen ion conductive electrolyte membrane 11 having positive ion conductivity was used as the solid electrolyte membrane configuring the electrochemical device 1, the electrochemical device 1 can also be configured by using a negative ion conductive electrolyte membrane, for example, Neosepta-AHA (manufactured by ASTOM Corporation). In an anode and a cathode of an electrochemical device using a negative ion conductive electrolyte membrane, the following electrochemical reactions and chemical reactions occur, whereby the nitrate ion can be electrochemically and chemically reduced and decomposed.

### [Electrochemical Device Using Negative Ion Conductive Electrolyte Membrane]

### Anodic Reaction:

5OH⁻→ 5/2H₂O+ 5/4O₂+5e^{- (electrochemical reduction reaction)}

Cathodic reaction:

2NO₃⁻+3H₂→N₂+2OH⁻+2H₂O (chemical reduction reaction)

NO₃⁻+3H₂O+5e⁻→½N₂+6OH^{- (electrochemical reduction reaction)}

### Overall Reaction:

NO₃⁻+½H₂O→½N₂+ 5/4O₂+OH⁻

As described previously, according to the present Embodiment 3, in the water treatment apparatus configured of the electrochemical device 1 having disposed therein the anode having the anode catalyst 121 and the anode electron conductive substrate 122 on one surface of the hydrogen ion conductive electrolyte membrane 11 and the cathode 13 having the cathode catalyst 131 and the cathode electron conductive substrate 132 on the other surface thereof, by providing to the cathode 13, as a reducing catalyst, a metal or a metal alloy containing at least one of copper (Cu), nickel (Ni) and palladium (Pd) and further providing, as a promoting catalyst, a platinum-group metal, it became possible to reduce and decompose electrochemically and chemically harmful substances with good efficiency.

Since the harmful substance removing filter 14 for removing poisonous gases discharged from the reaction chamber 133 was provided in the conduit 15q for making the reaction chamber 133 communicate with the gas discharge port 9b, the platinum-group catalyst supported on a porous metal oxide was used as the filter 14a for removing nitrogen oxides as harmful gases and the platinum-group catalyst supported on a porous body was used as the filter 14b for removing hydrogen as a harmful gas, a safe water treatment apparatus which is able to remove surely these harmful gases and which does not discharge the harmful gases out the system was obtained.

### Embodiment 4

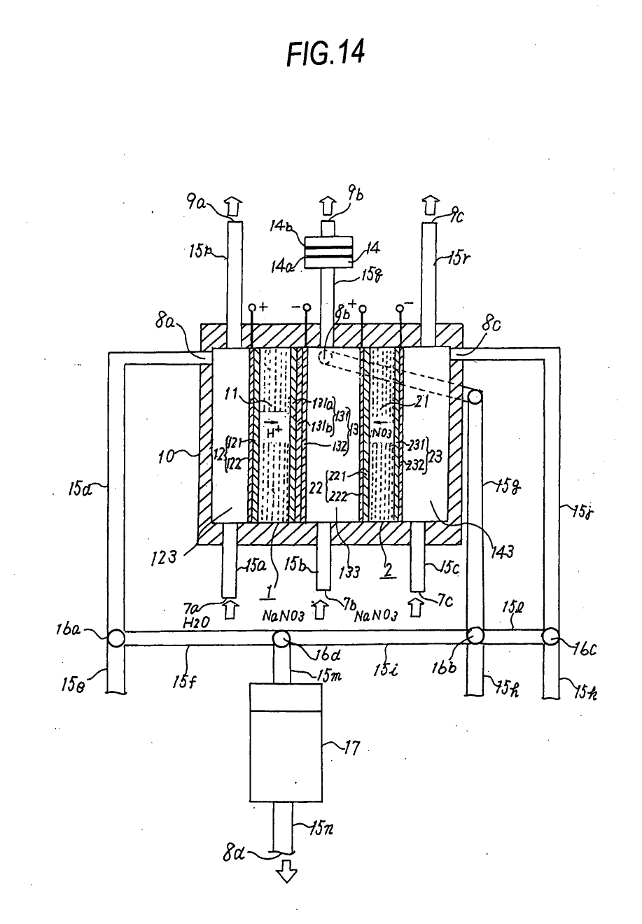

FIG. 14 is a view to show a configuration of a water treatment apparatus as Embodiment 4 of the invention. The present Embodiment 4 is to provide a water treatment apparatus which is able to reduce and decompose more efficiently harmful substances by combining a first electrochemical device 1 having an electrochemically reducing function and a second electrochemical device 2 having a harmful substance concentrating function.

The first electrochemical device 1 configuring the water treatment apparatus in the present Embodiment 4 is the same as the electrochemical device 1 of the foregoing Embodiment 3 and is provided with a hydrogen ion conductive electrolyte membrane 11 which is a solid electrolyte membrane having positive ion conductivity, an anode 12 which is a first anode provided on one surface of this hydrogen ion conductive electrolyte membrane 11 and a cathode 13 which is a first cathode provided on the other surface thereof. In the anode 12, an anode catalyst 121 and an anode electron conductive substrate 122 are cladded; and in the cathode 13, a cathode catalyst 131 and a cathode electron conductive substrate 132 are cladded.

In each of the anode 12 and the cathode 13, a wire gauze in which platinum is plated on an expanded metal of titanium for the purpose of strengthening the corrosion resistance is disposed as the electron conductive substrates 122 and 132, respectively so as to put the hydrogen ion conductive electrolyte membrane 11 therebetween from the both sides. The anode 12 is provided with platinum (Pt) as the anode catalyst 121 deposited on an electrode surface of the hydrogen ion conductive electrolyte membrane 11 by means of electroless plating.

The cathode 13 is provided with, as the cathode catalyst 131, a promoting catalyst 131a for promoting the generation of a hydrogen ion and a reducing catalyst 131b for reducing and decomposing a nitrate ion as a harmful substance. Concretely, similar to the foregoing Embodiment 3, platinum (Pt) deposited on the other surface of the hydrogen ion conductive electrolyte membrane 11 by means of electroless plating can be used as the promoting catalyst; and a metal containing at least one of copper (Cu), nickel (Ni) and palladium (Pd) or a metal alloy (for example, Cu—Ni, Cu—Pd, and Ni—Pd) can be used as the reducing catalyst metal.

On the other hand, the second electrochemical device 2 is provided with a hydroxyl ion conductive electrolyte membrane 21 which is a second solid electrolyte membrane having negative ion conductivity; an anode 22 which is a second anode provided on one surface of this hydroxyl ion conductive electrolyte membrane 21; and a cathode 23 which is a second cathode provided on the other surface thereof. In the anode 22, an anode catalyst 221 and an anode electron conductive substrate 222 are cladded; and in the cathode 23, a cathode catalyst 231 and a cathode electron conductive substrate 232 are cladded.

In each of the anode 22 and the cathode 23, a wire gauze in which platinum is plated on an expanded metal of titanium for the purpose of strengthening the corrosion resistance is disposed as the electron conductive substrates 222 and 232, respectively so as to put the hydroxyl ion conductive electrolyte membrane 21 therebetween from the both sides. Both the anode 22 and the cathode 23 are provided with platinum (Pt) deposited on an electrode surface of the hydroxyl ion conductive electrolyte membrane 21 by means of electroless plating as the anode catalyst 221 and the cathode catalyst 231, respectively.

The first electrochemical device 1 and the second electrochemical device 2 are accommodated in a reaction vessel 10. The reaction vessel 10 is provided with an anode chamber 123, a reaction chamber 133 and a cathode chamber 143 which are partitioned from each other by the first electrochemical device 1 and the second electrochemical device 2. The anode chamber 123 has a space coming into contact with the anode 12; and its inlet side (in a lower part in FIG. 14) is connected to a conduit 15a communicating with an introduction port 7a for water, i.e., ion exchange water in the present embodiment, whereas the other outlet side (in an upper part in FIG. 14) is connected to a conduit 15d for forming an ion exchange water discharge port 8a. This conduit 15d is connected to conduits 15f, 15m and 15n and communicates with a clean water discharge port 8d. An upper part of the anode chamber 123 is connected to a conduit 15p communicating with a gas discharge port 9a.

The reaction chamber 133 for reducing and decomposing harmful substances in water to be treated has a space coming into contact with both of the cathode 13 and the anode 22; and its inlet side is connected to a conduit 15b communicating with an introduction port 7b for water to be treated, whereas the other outlet side is connected to a conduit 15g for forming a treated water discharge port 8b. This conduit 15g is connected to conduits 15i, 15m and 15n and communicates with the clean water discharge port 8d. An upper part of the reaction chamber 133 is connected to a conduit 15q communicating with a gas discharge port 9b. Furthermore, the conduit 15q is provided with a harmful substance removing filter 14 the same as in the foregoing Embodiment 3, but its explanation is omitted.

Moreover, the cathode chamber 143 has a space coming into contact with the cathode 23, and its inlet side is connected to a conduit 15c communicating with an introduction port 7c for water to be treated, whereas the other outlet side is connected to a conduit 15j for forming a treated water discharge port 8c. This conduit 15j is connected to conduits 15l, 15i, 15m and 15n and communicates with the clean water discharge port 8d. An upper part of the cathode chamber 143 is connected to a conduit 15r communicating with a gas discharge port 9c.

An anode chamber discharge liquid which is discharged from the anode chamber 123, a reaction chamber discharge liquid which is discharged from the reaction chamber 133 and a cathode chamber discharge liquid which is discharged from the cathode chamber 143 pass through the conduits 15d and 15f, the conduits 15g and 15i and the conduits 15j, 15l and 15i, respectively, come together in the conduit 15m and are mixed in a pH adjustment tank 17. The mixed liquid, the pH of which has been adjusted, passes through the conduit 15n and is discharged from the clean water discharge port 8d. These discharge liquids are adjusted with respect to a flow amount by operating switching valves 16a, 16b, 16c and 16d, adjusted so as to have a dischargeable pH and then discharged. With respect to the anode chamber discharge liquid, the reaction chamber discharge liquid or the cathode chamber discharge liquid, there may be the case where the pH adjustment is not necessary depending upon a degree of the pH. In that case, these discharge liquids can be discharged from a conduit 15e, a conduit 15h and a conduit 15k, respectively by switching the switching valves 16a, 16b and 16c.

Next, the action of the water treatment apparatus provided with the first electrochemical device 1 and the second electrochemical device 2 in the present Embodiment 4 is briefly described. An NaNO₃ aqueous solution (water to be treated) containing a nitrate ion (NO₃⁻) as a harmful substance is introduced from the introduction port 7b for water to be treated into the reaction chamber 133 as a space coming into contact with both of the cathode 13 and the anode 22. The NaNO₃ aqueous solution (water to be treated) which is introduced from the introduction port 7c for water to be treated passes through the cathode chamber 143 as a space coming into contact with the cathode 23. Ion exchange water introduced from the introduction port 7a for ion exchange water passes through the anode chamber 123 as a space coming into, contact with the anode 12.

At that time, water (H₂O) is decomposed, and oxygen (O₂) is generated on the surface of the anode 12 of the first electrochemical device 1. H⁺ and H₃O⁺ as thus generated herein are conducted within the hydrogen ion conductive electrolyte membrane 11, move into the side of the cathode 13 and cause an electrochemical reduction reaction with NO₃⁻ in the reaction chamber 133. Furthermore, H₃O⁺ generates H₂ on the surface of the cathode 13, and a chemical reduction reaction of the nitrate ion simultaneously proceeds. Since the chemical reaction formulae and electrochemical reaction formulae which occur on the anode 12 and the cathode 13 of the first electrochemical device 1 are the same as in the foregoing Embodiment 3, their explanations are omitted herein.

On the other hand, the nitrate ion (NO₃⁻) as a harmful substance which is contained in the NaNO₃ aqueous solution introduced into the cathode chamber 143 passes through the hydroxyl ion conductive electrolyte membrane 21 and moves into the side of the reaction chamber 133 while making a concentration gradient of the nitrate ion to be formed within the hydroxyl ion conductive electrolyte membrane 21 of the second electrochemical device 2 and a potential gradient to be formed between the cathode 23 and the anode 22 as a driving force. Though there is a possibility that a part of the nitrate ion is discharged from the conduit 15j, it is possible to keep the driving force high and to increase a proportion of the nitrate ion which moves into the side of the reaction chamber 133 by increasing the concentration gradient (concretely, thinning the hydroxyl ion conductive electrolyte membrane 21, reducing quickly the nitrate ion in the reaction chamber 133, increasing a catalyst reaction interface by means of making the catalyst particle fine, or the like) and increasing the potential gradient (concretely, increasing a terminal-to-terminal voltage, thinning the hydroxyl ion conductive electrolyte membrane 21, or the like).

That is, the second electrochemical device 2 has a harmful substance concentrating function, and in addition to this concentrating function, the hydrogen ion concentration increases by lowering the pH. Accordingly, a reduction efficiency of the nitrate ion to nitrogen is enhanced, and the production of a nitrite ion (NO₂⁻) produced in a process of the reduction of the nitrate ion is inhibited. The chemical reaction formulae and electrochemical reaction formulae which occur on the anode 22 and the cathode 23 of the second electrochemical device 2 are hereunder shown.

### [Second Electrochemical Device 2]

Anodic reaction: 5OH⁻→ 5/2H₂O+ 5/4O₂+5e^{- (electrochemical reduction reaction)}

Cathodic reaction: 2NO₃⁻+3H₂→N₂+2OH⁻+2H₂O (chemical reduction reaction)

NO₃⁻+3H₂O+5e⁻→½N₂+6OH^{- (electrochemical reduction reaction)}

Overall reaction:

NO₃⁻+½H₂O→½N₂+ 5/4O₂+OH⁻

As is clear from the foregoing formulae, though harmless nitrogen gas (N₂) is produced on the cathode 23 of the second electrochemical device 2, a small amount of hydrogen is also generated by a side reaction (H₂O+e⁻→OH⁻+½H₂) on the cathode 23. That is, a nitrogen gas and a small amount of a hydrogen gas are discharged from the gas discharge port 9c of the cathode chamber 143. Thus, a hydrogen removing filter may be provided in the conduit 15r, if desired.

According to the present Embodiment 4, by combining the first electrochemical device 1 having an electrochemical reducing function and the electrochemical device 2 having a harmful substance concentrating function, in addition to the same effects as in Embodiment 3, it became possible to reduce and decompose more efficiently harmful substances as compared with the case of only the first electrochemical device 1. Details are mentioned in the following (1), (2) and (3).

### (1) Concentrating Effect of Nitrate Ion NO₃⁻:

In the drinking water standards based on the current domestic Waterworks Law, a standard value of each of nitrate nitrogen and nitrite nitrogen is not more than 10 (mg/L), which value is, however, lax by 10,000 times as compared with the Canadian value of not more than 0.001 (mg/L). In view of the matter that healthy damage caused due to nitrate nitrogen is becoming actualized, it is inevitable that the standard value becomes strict. In electrochemically reducing the nitrate ion on such a low-concentration level by a single device, as shown in Embodiment 4, by combining a positive ion conductive solid electrolyte device and a negative ion conductive solid electrolyte device, concentrating a nitrate ion through the movement from an anode to a cathode by using the negative ion conductive solid electrolyte device and reducing the nitrate ion on the cathode side of the positive ion conductive solid electrolyte device, it has become possible to use the concentration of a low-concentration nitrate ion together with the electrochemical reduction, and the treatment has become easy. In the case of using singly a positive ion conductive solid electrolyte device, since only the positive ion is able to move within the electrolyte, a concentrating function of the nitrate ion cannot be expected; and in the case of using singly the negative ion conductive solid electrolyte device, since a concentrating effect of the nitrate ion is obtained on the anode, and a reducing effect of the nitrate ion is obtained on the cathode. Accordingly, it is necessary that the nitrate ion which has moved into the side of the anode is separately subjected to reduction treatment, and therefore, such was not efficient.

### (2) Enhancement of Current Efficiency:

Since the nitrate ion was electrochemically reduced after increasing its concentration, a rate of nitrate ion reduction at an energizing current increased, whereby enhancement of the current efficiency could be realized.

### (3) Simplification of Structure:

In the case of using individually a positive ion conductive solid electrolyte device and a negative ion conductive solid electrolyte device, four chambers in total of two anode chambers and two cathode chambers are formed. However, as shown in Embodiment 4, in the case of using a combination of a positive ion conductive solid electrolyte device and a negative ion conductive solid electrolyte device, it is possible to take a structure of forming three chambers in total by making a cathode chamber of the positive ion conductive solid electrolyte device and an anode chamber of the negative ion conductive solid electrolyte device common, and the structure is simplified, whereby economical merits are obtainable.

Various changes and modifications of the invention can be easily realized by those skilled in the art without departing from the viewpoint and spirit thereof, and it should be construed that the invention is not limited to the embodiments which have been illustrated and described.

### INDUSTRIAL APPLICABILITY

The invention can be utilized as a harmful gas treatment apparatus for removing nitrogen oxides contained in an exhaust gas which is discharged from an internal combustion engine or the like upon reduction and decomposition. Also, the invention can be utilized as a water treatment apparatus for removing a harmful nitrate ion contained in water to be treated upon reduction and decomposition.

1. A harmful gas treatment apparatus comprising:
a first electrochemical device including a first solid electrolyte membrane having positive ion conductivity, a first anode provided on one surface of the first solid electrolyte membrane and a first cathode provided on the other surface of the first solid electrolyte membrane;
a second electrochemical device including a second solid electrolyte membrane having negative ion conductivity, a second anode provided on one surface of the second solid electrolyte membrane and a second cathode provided on the other surface of the second solid electrolyte membrane;
a reducing catalyst provided in at least the first cathode and the second cathode for reducing and decomposing harmful substances in the harmful gas to be treated; and
a reaction tank having a space coming into contact with both of the first cathode and the second cathode and communicating with an introduction port and a discharge port of the harmful gas to be treated.

2. The harmful gas treatment apparatus according to claim 1, wherein the harmful gas to be treated contains nitrogen oxides.

3. The harmful gas treatment apparatus according to claim 1, wherein a suppressive catalyst is provided in at least one of the first cathode and the second cathode for suppressing an electrochemical reaction of hydrogen and oxygen.

4. The harmful gas treatment apparatus according to claim 3, wherein gold (Au) is used as the suppressive catalyst.

5. The harmful gas treatment apparatus according to claim 1, wherein a catalyst layer of a metal oxide and a platinum group supported on a porous body having functions to occlude and concentrate harmful substances is used as the reducing catalyst.

6. A water treatment apparatus comprising:
an electrochemical device including a solid electrolyte membrane having ion conductivity, an anode provided on one surface of the solid electrolyte membrane and a cathode provided on the other surface of the solid electrolyte membrane;
a reaction vessel accommodating the electrochemical device therein, and including an anode chamber having a space coming into contact with the anode and communicating with an introduction port and a discharge port of water, and a reaction chamber having a space coming into contact with the cathode and communicating with an introduction port and a discharge port of water to be treated; and
a reducing catalyst provide in the cathode for reducing and decomposing harmful substances in water to be treated and a promoting catalyst provided in the cathode for promoting a reaction for producing hydrogen.

7. A water treatment apparatus comprising:
a first electrochemical device including a first solid electrolyte membrane having positive ion conductivity, a first anode provided on one surface of the first solid electrolyte membrane and a first cathode provided on the other surface of the first solid electrolyte membrane;
a second electrochemical device including a second solid electrolyte membrane having negative ion conductivity, a second anode provided on one surface of the second solid electrolyte membrane and a second cathode provided on the other surface of the second solid electrolyte membrane;
a reaction vessel accommodating the first electrochemical device and the second electrochemical device therein, and including an anode chamber having a space coming into contact with the first anode and communicating with an introduction port and a discharge port of water, a reaction chamber having a space coming into contact with both of the first cathode and the second anode and communicating with an introduction port and a discharge port of water to be treated, and a cathode chamber having a space coming into contact with the second cathode and communicating with the introduction port and the discharge port of water to be treated; and
a reducing catalyst provided in the first cathode for reducing and decomposing harmful substances in water to be treated and a promoting catalyst provided in the first cathode for promoting a reaction for producing hydrogen.

8. The water treatment apparatus according to claim 6, wherein the water to be treated contains a nitrate ion.

9. The water treatment apparatus according to claim 6, wherein the reducing catalyst contains at least one of copper (Cu), nickel (Ni) and palladium (Pd).

10. The water treatment apparatus according to claim 6, wherein a platinum-group metal is used as the promoting catalyst.

11. The water treatment apparatus according to claim 6, wherein the reaction chamber communicates with a gas discharge port and a conduit for making the reaction chamber communicate with the gas discharge port is provided with a filter for removing poisonous gases discharged from the reaction chamber.

12. The water treatment apparatus according to claim 11, wherein the poisonous gases discharged from the reaction chamber contain nitrogen oxides and a platinum-group catalyst supported on a porous metal oxide is used as the filter for removing the nitrogen oxides.

13. The water treatment apparatus according to claim 11, wherein the poisonous gases discharged from the reaction chamber contain hydrogen and a platinum-group catalyst supported on a porous body is used as the filter for removing the hydrogen.

14. The water treatment apparatus according to claim 7, wherein the water to be treated contains a nitrate ion.

15. The water treatment apparatus according to claim 7, wherein the reducing catalyst contains at least one of copper (Cu), nickel (Ni) and palladium (Pd).

16. The water treatment apparatus according to claim 7, wherein a platinum-group metal is used as the promoting catalyst.

17. The water treatment apparatus according to claim 7, wherein the reaction chamber communicates with a gas discharge port and a conduit for making the reaction chamber communicate with the gas discharge port is provided with a filter for removing poisonous gases discharged from the reaction chamber.

18. The water treatment apparatus according to claim 17, wherein the poisonous gases discharged from the reaction chamber contain nitrogen oxides and a platinum-group catalyst supported on a porous metal oxide is used as the filter for removing the nitrogen oxides.

19. The water treatment apparatus according to claim 17, wherein the poisonous gases discharged from the reaction chamber contain hydrogen and a platinum-group catalyst supported on a porous body is used as the filter for removing the hydrogen.
